(19) United States
(12) Patent Application Publication
(10) Pub. No.: US 2012/0134489 A1
(43) Pub. Date: May 31, 2012

(54) Dynamic digit mapping based on a connected party and methods thereof

(75) Inventors: Peter M. Hillier, Ottawa (CA); Katayoun Hillier, Ottawa (CA)

(73) Assignee: Mitel Networks Corporation

(21) Appl. No.: 12/927,992

(22) Filed: Nov. 30, 2010

(51) Int. Cl. H04M 9/00

(52) U.S. Cl. 379/399.01

(57) ABSTRACT

A method, user configurable interface and communication device for dynamic digit mapping based on a connected party. In one illustrative embodiment, the keypad can include a user configurable interface for dual-tone multi-frequency driven systems. The keypad can have an electronic memory storing associations between user entries to system entries for a dialed number. A generator circuit can be coupled to the electronic memory and have an input terminal to receive user entries and a terminal to transmit digits corresponding to the system entries for the dialed number. A program executable on the generator circuit can receive a user entry for the dialed number, map the user entry to a system entry using the associations stored within the electronic memory and provide output corresponding to the system entry through the terminal to the dialed number.

### TECHNICAL FIELD

This application generally relates to telecommunications, and more particularly, to an interface for communicating with dual-tone multi-frequency driven systems using user configurations defined on the interface.

### BACKGROUND

Dual-tone multi-frequency (DTMF) digits are provided to a phone system when ordinary telephone touch keys are pressed. DTMF digits can be sent in-band or out-of-band, but the most popular, standards-based approach used today is to send DTMF digits in-band. In-band relates to the real-time transport protocol media stream, while out-of-band relates to the signaling path. RFC 2833 is the standards-based mechanism used to send DTMF digits in-band that is supported by many vendors in the industry.

Devices send DTMF digits when a phone call is routed to a phone system. Automated attendant, voicemail, or interactive voice response systems are some examples of the types of phone systems that can pick up phone calls. These tones are then decoded by the phone systems to determine which key was pressed to take appropriate actions. In voicemail systems, DTMF digits allow a user to signal the phone system to play, delete, skip or save recordings. Currently, however, there is no standard interface to insure a common look and feel for users. Often times an individual's home, cell, and work systems require different key presses to handle the same standard actions. For example, when a “4” on the individual's cell is keyed in, a voicemail message is saved, while the same key on their work system represents deleting the message.

While voice activated commands are used to overcome these challenges, they are not common place on existing phone systems. The present application addresses the above-described issues encountered in signal systems as well as other related advantages.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 depicts exemplary dual-tone multi-frequency (DTMF) driven systems in contact with a communication device in accordance with one aspect of the present application;

FIG. 2 provides an illustrative user configurable interface for the communication device to provide remapping of key entries in accordance with one aspect of the present application;

FIG. 3 shows exemplary hardware and software components of a typical communication device in accordance with one aspect of the present application;

FIG. 4 is a flow chart depicting illustrative processes for setting up key mappings in accordance with one aspect of the present application; and

FIG. 5 is a flow chart showing exemplary processes for mapping key entries in accordance with one aspect of the present application.

### DESCRIPTION OF THE APPLICATION

The description set forth below in connection with the appended drawings is intended as a description of presently-preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

The present application relates to dynamic digit mappings on a keypad based on a connected party and methods thereof. In one illustrative embodiment, the keypad can include a user configurable interface for communicating with multiple dual-tone multi-frequency (DTMF) driven systems. The keypad can have an electronic memory storing associations between user entries to system entries for a dialed number. User entries can refer to input provided by a user while system entries can refer to input provided to the DTMF driven systems to activate a specific function. A generator circuit can be coupled to the electronic memory and have an input terminal to receive user entries and a terminal to transmit DTMF output corresponding to the system entries for the dialed number. A program executable on the generator circuit can receive a user entry for the dialed number, map the user entry to a system entry using the associations stored within the electronic memory and provide DTMF output corresponding to the system entry through the terminal to the dialed number.

Numerous advantages can be provided through the user configurable interface described above. The interface resolves configuration issues at the source, and in this case, the communication device being used to access the DTMF driven systems. No changes to legacy systems are typically required, including software upgrades. Key mappings can be created within the communication device, and they can be applied when the device is connected to the DTMF driven system. Once the call is disconnected or the feature is disabled, the regular keypad associations can be restored.

Primarily described as working with DTMF signals, those skilled in the relevant art will appreciate that other telecommunication signaling can be used by the user configurable interface. Other tone dialing driven systems can also be implemented as will become apparent from the description provided below. While the term communication device is referred to throughout the present application, the communication device can take on other names known in the relevant art, for example, computing or mobile apparatus.

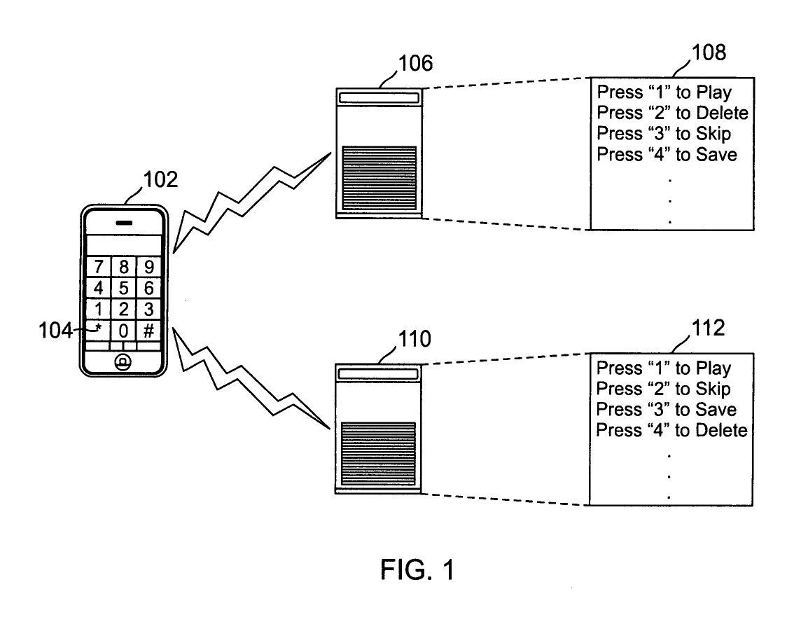

Referring to FIG. 1, exemplary DTMF driven systems 106 and 110 in contact with a communication device 102 in accordance with one aspect of the present application are provided. For purposes of illustration, the depicted DTMF driven systems 106 and 110 are voicemail systems. In other configurations, the systems are not limited to handling voicemails, but can also provide other services that receive tone dialing as input. For example, the DTMF driven systems can provide services in automated banking or shopping services. DTMF driven systems can support skill-based routing and full automatic call distribution functionality. Automated systems can use DTMF digits for various items including menu navigation. The communication device 102 can interact with one or more systems and is not limited to the two voicemail systems 106 and 110 as shown.

Turning now to the communication device 102, a keypad 104 can be included that allows a user to provide input through key presses. The keypad 104 can be a numeric keypad, or include other keys that can increase its functionality. The keypad 104 can be hardwired or be provided on a touch display. The communication device 102 can receive user input and provide it to DTMF driven systems, for example, the voicemail systems 106 and 110. Typically, the key press produces a tone for the systems. RFC 2833 is generally not supported on older “Type A” phones. “Type B” phones, however, do support RFC 2833. Media termination points are typically required when a device requiring RFC 2833 is in a phone call with a device 102 that only supports out-of-band mechanisms and DTMF digits are used.

Depending on the number called, the tone through the press of a key on the keypad 104 can provide different commands to the DTMF driven systems. As shown in FIG. 1, when a “4” is provided as a tone to system 106, the system entry 108 indicates that the system 106 can save the voicemail message. When a “4” is provided as a tone to system 110, however, the system entry 112 would indicate that the system 110 delete the message. Saving and deleting a message are entirely different and thus, it would be important to provide user options from the communication device 102 that would avoid any confusion.

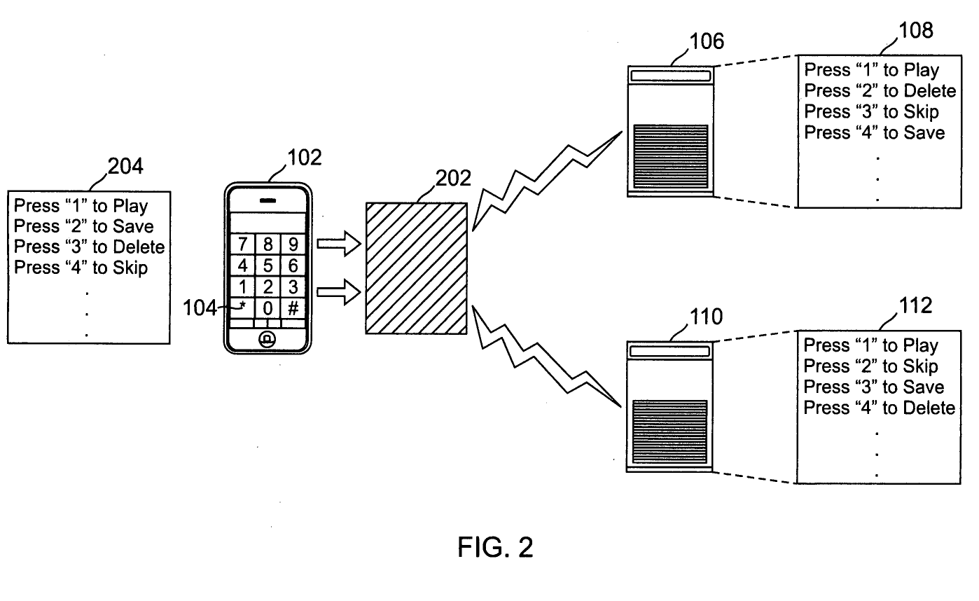

To remove the confusion, a user configurable interface can be implemented. FIG. 2 provides an illustrative user configurable interface 202 for the communication device 102 to provide remapping of key entries in accordance with one aspect of the present application. The user configurable interface 202, in typical embodiments, can be used to provide a set of user options 204 that can be standard to different DTMF driven systems, such as the voicemail systems 106 and 110.

Through the user configurable interface 202, user options 204 can be standardized. For example, when a “1” is pressed within the keypad 104, both voicemail systems 106 and 110 would be directed to play the message. Pressing “2” would save the message, “3” would delete the message and “4” would skip the message. The user configurable interface 202 can allow these manipulations without the user knowing. The user configurable interface 202 can take key presses from the keypad 104, remap them, and provide it to the systems to perform the specific system entries 108 and 110.

Continuing with the previous example described above, when a “2” is pressed in the user options 204 on the keypad 104 of the communication device 102, which corresponds to saving a voicemail, the user configurable interface 202 can remap the user entry to an appropriate system entry 108 and 112 for the systems 106 and 110. To save a voicemail, the user configurable interface 202 can provide a system entry of “4” to system 106 and a system entry of “3” to system 110.

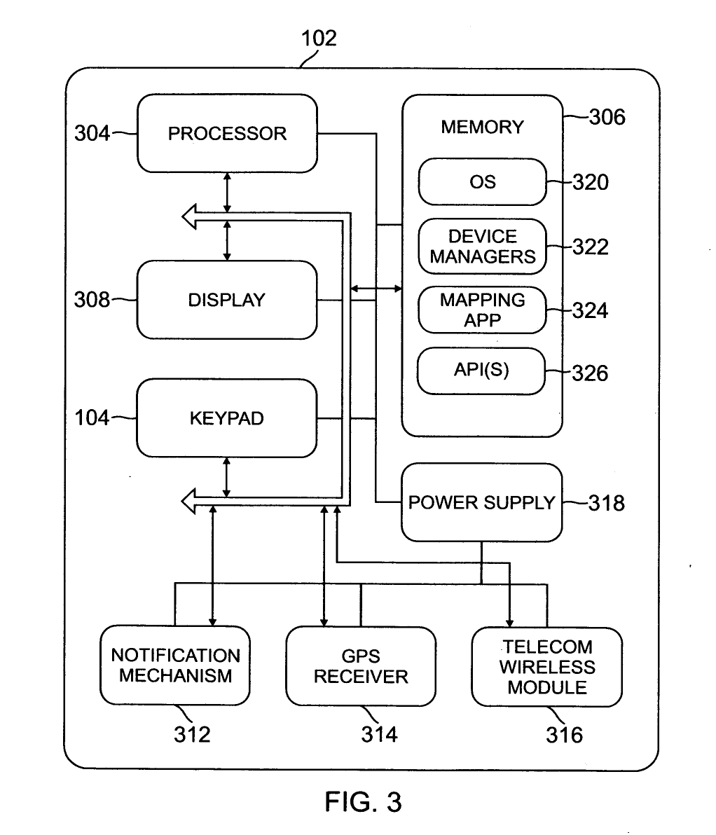

Referring now to FIG. 3, the hardware and software of a communication device 102 will be described below. The communication device 102 can have a processor 304 for implementing logic, a memory 306, a display 308, and a keypad 104. The display 308 of the communication device 102 can be a liquid crystal display (LCD), or any other type of display commonly used in communication devices 102. The display 308 can be touch-sensitive, and can act as an input device. The keypad 104 can be a push button numeric dialing pad such as on a typical telephone, a multi-key keyboard such as a conventional keyboard or any other device for inputting textual data. In some communication devices 102, the keypad 104 can be shown on the display 308 allowing the touch-sensitive display 308 to act as the keypad 104.

The memory 306 generally includes both volatile memory, e.g., RAM, and non-volatile memory e.g., ROM, Flash Memory, or the like. The non-volatile portion of the memory 306 can be used to store persistent information which should not be lost when the communication device 102 is powered down. The communication device 102 can include an operating system (OS) 320, such as Windows CE® or Windows Mobile® available from Microsoft Corporation, Redmond, Wash., or other OS. The OS can reside in the memory 306 and be executed on the processor 304.

The memory 306 can also include one or more device managers 322 for interacting with one or more I/O devices. The device managers 322 can be software installed on the communication device 102. A device manager 322 can correspond to each I/O device. Within the memory 306, a mapping application 324 can be run on the communication device 102, which allows the user to configure user options 204 as well as map user entries to system entries. The mapping application 324 can be installed on the communication device 102 through a network connection or via a direct link. Alternatively, the mapping application 324 can be preinstalled and can be part of the operating system 320 described above. The mapping application 324 can be programmed by the user, which will be described further below.

The memory 306 can also include a collection of one or more APIs 326 for facilitating wireless communications between the communication device 102 and one or more remote I/O devices. The APIs 326 can be invoked by the applications to recognize and control the one or more remote I/O devices. In this manner, the communication device 102 is able to take advantage of services or functionalities of the one or more remote I/O devices.

The communication device 102 can also include a power supply 318, which can be implemented as one or more batteries, fuel cells, or other sources of electrical power. The power supply 318 might further include an external power source, such as an AC adapter or a powered docking cradle that supplements or recharges the batteries. The communication device 102 can also include one or more audio, visual, and/or vibratory notification mechanisms 312. These notification mechanisms 312 can be directly coupled to the power supply 318 so that when activated, they remain on for a duration dictated by the notification mechanism 312 even though the processor 304 and other components might shut down to conserve energy. The communication device 102 can also include at least one GPS receiver 314 that can facilitate determining location information of the communication device 102. The mobile phone 102 can include a telecommunications wireless module 316, such as a GPS or WiFi module that facilitates wireless connectivity between the communication device 102 and the outside world via the communications network.

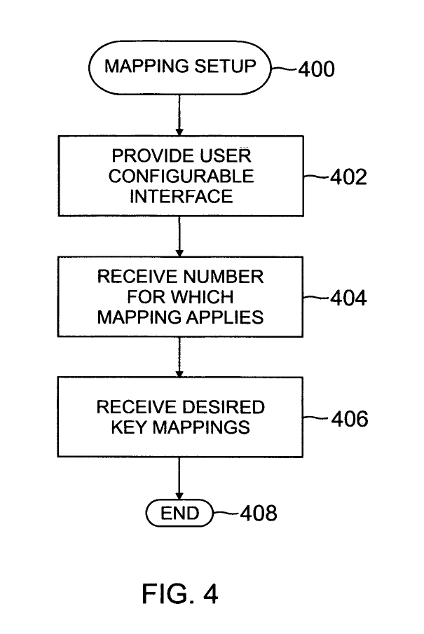

In FIG. 4, a flow chart depicting illustrative processes for setting up key mappings in accordance with one aspect of the present application is provided. While primarily depicted as being configured on the communication device 102, those skilled in the relevant art will appreciate that the interface 202 can be configured using a personal computer or other computing device whereby the mappings can be downloaded from. Those processes described below represent one embodiment. It should not be construed as the only embodiment as fewer, more or other processes can be used.

The processes for setting up the mapping application 324 can begin at block 400. At block 402, the user configurable interface 202 can be provided to the user. The user configurable interface 202 can provide menus and other selections that make it user-friendly to enter in mappings. The mappings can refer to associating user options 204 to system entries 108 and 112 as described in FIG. 2. At block 404, the user configurable interface 202 can receive the number for which the mapping will apply to, for example, the number to a DTMF driven system such as the voicemail systems 106 and 110.

At block 406, the user configurable interface 202 can receive desired key mappings. In one embodiment, the user can be provided with a list of user options 204. The user can provide a key entry to be associated with a specific user option 204. For example, in the voicemail interface described above, the user options 204 can include play, save, delete and skip, which can be modified to include fewer or additional options. The user can then provide keys for each. As shown in FIG. 2, the user can specify “1” for playing the voicemail, “2” for saving the voicemail, “3” for deleting the voicemail, and “4” for skipping the voicemail. The user options 204 can then be saved in the mapping application 324 of the communication device 102.

Thereafter, the user options 204 can be associated with system entries 108 and 112. For example, if the user wanted “3” to signify to system 106 to delete a voicemail, but the system 106 operates with “2” to delete, then an association between the user option 204 and the system entry 108 would be mapped. In one embodiment, the user can provide these associations. Alternatively, the communication device and the DTMF signaling driven systems 106 and 110 can communicate with each other to match these options. The processes can end at block 408. Those processes shown in FIG. 4 can be repeated to establish multiple mappings between user options 204 and system entries 108 and 112.

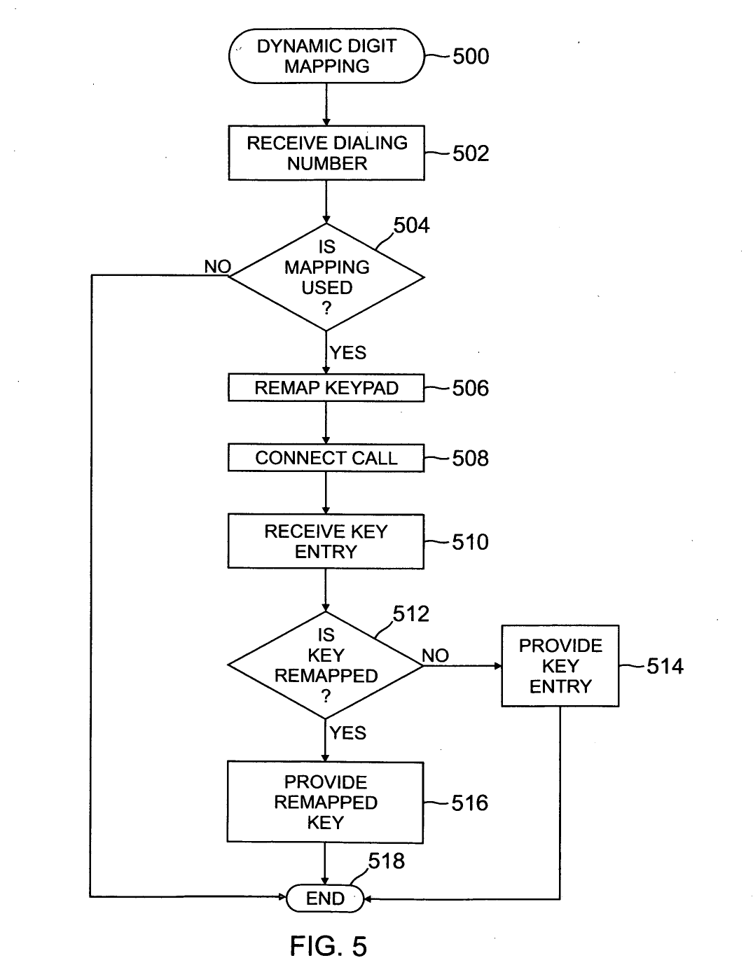

After the mapping application 324 has been setup, key entries can be mapped to system entries 108 and 112 in accordance with one aspect of the present application as shown in FIG. 5. Those processes described below represent one embodiment. It should not be construed as the only embodiment as fewer, more or different processes can be used. At block 500, the processes can begin.

At block 502, the user configurable interface 202 can receive a dialing number indicating the DTMF driven system to be called. In voicemail systems, the number is automatically dialed when the user selects the voicemail option. Alternatively, the user can directly dial the number themselves. At decision block 504, a determination can be made whether key mappings are used. This determination can be made based on the dialing number received.

If mappings have not been established, the communication device 102 can connect the call to the dialing number. In one embodiment, the user can communicate with each system individually. Continuing with the voicemail systems 106 and 110 described above, the user can press “3” to skip a voicemail message for system 108 and a “2” to system 110 for the same function. The processes can end at block 518.

When mappings have been configured, at block 506, the keypad is remapped in accordance with those associations provided in the setup phase. Continuing with the previous illustration, the user options 204 can be provided to the user indicating that pressing “1” will play the voicemail, “2” will save the voicemail, “3” will delete the voicemail, and “4” will skip the voicemail. Other configurations can be used dependent on the setup phase described earlier. At block 508, the call can be connected to the system associated with the dialing number. The call can be connected before or after a decision is made to remap the keypad.

In one embodiment, the user configurable interface 202 can present a visual indication that key mappings have been enabled. This early indication system can provide the user awareness of the feature. In other embodiments, audible indications can be provided by the user configurable interface 202.

At block 510, the user can then provide a key entry through keypad 104. The key entry can correspond to the user options 204 that were established during setup time. At decision block 512, a determination can be made whether the key entry has been remapped. At block 514, the key entry is provided without translation or modification when mappings have not been found for the specific key entry. Otherwise, the mapped key is provided at block 516. For both, a tone can be generated for the key entry and provided to the DTMF driven systems. In one embodiment, the phone can generate an applicable DTMF tone or RFC 2833 message. The processes can end at block 518. The user of the communication device 102, at any time, can disable the key mappings via the user configurable interface 202.

While primarily described as mapping key entries to system entries, those skilled in the relevant art will appreciate that the systems and methods described herein can be used for other types of input provided by the user of the communication device 102. In one embodiment, voice activated systems can also be remapped. Software, hardware or a combination thereof on the communication device 102 can be used to configure the interface 202 such that voice commands are altered. For example, when the user speaks into the communication device 102 “Discard”, it can be remapped to “Delete.”

In accordance with one aspect of the present application, a method for communicating with a plurality of tone driven systems through a common interface is provided. The method can include connecting a call to a tone driven system based on a dialed number. In addition, the method can include determining whether said tone driven system requires recodifying user input based on said dialed number. The method can also include translating said user input dependent on said determination and providing a tone to said tone driven system based on said user input.

In one embodiment, the method can include configuring the common interface. In one embodiment, wherein configuring the common interface can include receiving associations for the user input and the translated user input for the dialed number. In one embodiment, wherein configuring the common interface can occur before connecting the call to the tone driven system.

In one embodiment, wherein translating the user input dependent on the determination can include recodifying the user input when the common interface has been configured for the dialed number otherwise using unmodified user input. In one embodiment, the method can include providing a visual indication that the user input has been translated. In one embodiment, the method can include providing an audible indication that the user input has been translated. In one embodiment, the method can include removing the translation of the user input.

In accordance with another aspect of the present application, a user configurable interface for normalizing user entries provided to dual-tone multi-frequency driven systems is provided. The user configurable interface can include an electronic memory storing associations between user entries to system entries for a dialed number. In addition, the user configurable interface can include a generator circuit coupled to the electronic memory having an input terminal to receive the user entries and an output terminal for transmitting digits corresponding to the system entries for the dialed number. The user configurable interface can also include a program executable on the generator circuit for receiving a user entry for the dialed number, mapping the user entry to a system entry using the associations stored within the electronic memory and providing a digit corresponding to the system entry through said output terminal to the dialed number.

In one embodiment, the user configurable interface can include associations between the user entries to other system entries for another dialed number. In one embodiment, the associations can be defined by a user using the configurable interface. In one embodiment, the generator circuit can be a standard keypad.

In one embodiment, the interface can be provided on a mobile device. In one embodiment, the interface can be provided on a computing device. In one embodiment, the output terminal can be connected to a phone system for interpreting the digit.

In accordance with yet another aspect of the present application, a communication device is provided. The device can include a keypad and at least one processor. In addition, device can include a memory operatively coupled to the processor, the memory storing program instructions that when executed by the processor, causes the processor to perform processes. The processes can include receiving a number from the keypad to call and connecting the call to the number. In addition, the processes can include receiving a key press from the keypad and reclassifying the key press dependent on the number. The processes can also include providing output corresponding to the key press to an automated system.

In one embodiment, wherein reclassifying the key press can include determining whether the number has been configured for reclassifying the key press. In one embodiment, the automated system can be a voicemail service. In one embodiment, the output can be a dual-tone multi-frequency tone. In one embodiment, the output can be a RFC 2833 tone.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A method for communicating with a plurality of tone driven systems through a common interface, said method comprising:
connecting a call to a tone driven system based on a dialed number;
determining whether said tone driven system requires recodifying user input based on said dialed number;
translating said user input dependent on said determination; and
providing a tone to said tone driven system based on said user input.

2. The method of claim 1, further comprising configuring said common interface.

3. The method of claim 2, wherein configuring said common interface comprises receiving associations for said user input and said translated user input for said dialed number.

4. The method of claim 2, wherein configuring said common interface occurs before connecting said call to said tone driven system.

5. The method of claim 2, wherein translating said user input dependent on said determination comprises recodifying said user input when said common interface has been configured for said dialed number otherwise using unmodified user input.

6. The method of claim 1, further comprising providing a visual indication that said user input has been translated.

7. The method of claim 1, further comprising providing an audible indication that said user input has been translated.

8. The method of claim 1, further comprising removing said translation of said user input.

9. A user configurable interface for normalizing user entries provided to dual-tone multi-frequency driven systems comprising:
an electronic memory storing associations between user entries to system entries for a dialed number;
a generator circuit coupled to said electronic memory having an input terminal to receive said user entries and an output terminal for transmitting digits corresponding to said system entries for said dialed number; and
a program executable on said generator circuit receiving a user entry, mapping said user entry to a system entry using said associations stored within said electronic memory and providing a digit corresponding to said system entry through said output terminal to said dialed number.

10. The user configurable interface of claim 9, wherein said electronic memory stores further associations between said user entries to other system entries for another dialed number.

11. The user configurable interface of claim 9, wherein said associations are defined by a user using said configurable interface.

12. The user configurable interface of claim 9, wherein said generator circuit is a standard keypad.

13. The user configurable interface of claim 9, wherein said interface is provided on a mobile device.

14. The user configurable interface of claim 9, wherein said interface is provided on a computing device.

15. The user configurable interface of claim 9, wherein said output terminal is connected to a phone system for interpreting said digit.

16. A communication device comprising:
a keypad;
at least one processor; and
a memory operatively coupled to said processor, said memory storing program instructions that when executed by said processor, causes said processor to:
receive a number from said keypad to call;
connect said call to said number;
receive a key press from said keypad;
reclassify said key press dependent on said number; and
provide output corresponding to said key press to an automated system.

17. The communication device of claim 16, wherein reclassifying said key press comprises determining whether said number has been configured for reclassifying said key press.

18. The communication device of claim 16, wherein said automated system is a voicemail service.

19. The communication device of claim 16, wherein said output is a dual-tone multi-frequency tone.

20. The communication device of claim 16, wherein said output is a RFC 2833 tone.
